(19) United States
(12) Patent Application Publication
(10) Pub. No.: US 2013/0260354 A1
(43) Pub. Date: Oct. 3, 2013

(54) METHOD AND SYSTEM FOR EVALUATING CONTENT OBJECTS PUBLISHED ON A COLLABORATIVE PLATFORM

(71) Applicant: LOUDCLOUD SYSTEMS INC., Dallas, TX (US)

(72) Inventors: Manoj Kutty, Dallas, TX (US); Anil Vishwanath Sonkar, Andheri (IN); Ramesh Babu Chowdaiah Tatimatla, Guntur (IN); Dinesh Warrier, Mumbai (IN)

(73) Assignee: LoudCloud Systems Inc., Dallas, TX (US)

(21) Appl. No.: 13/853,371

(22) Filed: Mar. 29, 2013

Related U.S. Application Data
(60) Provisional application No. 61/618,522, filed on Mar. 30, 2012.

(51) Int. Cl. G09B 5/00

(52) U.S. Cl. CPC G09B 5/00
USPC 434/350

(57) ABSTRACT

Disclosed is a method and system for evaluating at least one content object received from at least one user through an input module in a collaborative platform. The system comprises an analyzing module, a publishing module, an evaluation module and a display module. The analyzing module is configured to detect whether the at least one content object is extraneous. The publishing module is configured to publish the at least one content object not detected as extraneous. After publishing, the evaluation module verifies whether the at least one content object or any other content object has been previously published by the at least one user. Based on the verification, the evaluation module selectively enables at least one other user to assign a preliminary score or a secondary score the at least one content object and to optionally mark the at least one content object assigned with the secondary score as ‘substantive’.

### PRIORITY CLAIM

This disclosure claims priority under 35 U.S.C. §119 to U.S. Provisional Application No. 61/618,522, filed Mar. 30, 2012, and entitled “AN ELECTRONIC FORUM FOR ENHANCING ONLINE LEARNING TECHNOLOGY.” The aforementioned application is incorporated herein by reference in its entirety.

### TECHNICAL FIELD

The present subject matter described herein, in general, relates to a collaborative platform such as an electronic forum, and in particular to the electronic forum facilitating the evaluation of content objects published thereon.

### BACKGROUND

Today online discussion platforms such as online forums have become an important discussion places amongst users connected with each other through the Internet or intranet. The online forums provide shared area where the users post messages (generally called “posts”) to be viewed, modified or commented by other users on a topic of shared interest. The online forums may be of several types such as web forums, message boards, discussion forums, bulletin boards or discussion boards that involve users in one-on-one messaging, collaborative meetings, news or event postings etc. There is immense utility of such forums in today's social context. The online forums further facilitate the users to participate in an asynchronous discussion using text, multimedia or through sharing of electronic objects such as spread sheets, word processing files, html files or combinations thereof.

Generally, the online forums help the users to enhance their understanding on a topic of interest by facilitating discussions amongst different users. Thus, in other words the online forums can be defined as centralized knowledge sharing platforms that enable multiple users to collaborate in order to gain or spread knowledge on a specific topic. However, since there are large numbers of such posts on the online forums, a user who is interested in a specific post may have to manually scroll the entire posts to identify at least one post of his interest. Further, majority of the posts are irrelevant, abusive or repetitive. This scenario is of material importance to the e-learning industry where it is important to identify posts that require grading or evaluation to judge engagement level of a student in virtual classroom forum.

### SUMMARY

This summary is provided to introduce aspects related to systems and methods for evaluating at least one content object (post) in a collaborative platform and the aspects are further elaborated below in the detailed description. This summary is not intended to identify essential features of the claimed subject matter nor is it intended for use in determining or limiting the scope of the claimed subject matter.

In one implementation, a system for evaluating at least one content object in a collaborative platform is disclosed. The system comprises at least one processor and a memory coupled to the at least one processor for executing a plurality of modules and data stored in the memory. The plurality of modules comprises an input module, an analyzing module, a publishing module, an evaluation module and a display module whereas the data comprises a content object database and a role database. The input module is configured to receive the at least one content object from at least one user on the collaborative platform. The analyzing module is configured to analyze content of the at least one content object to detect whether the content of the at least one content object is extraneous. The publishing module is configured to publish the at least one content object on the collaborative platform when the content of the at least one content object is not detected as extraneous. The evaluation module is configured to verify whether the at least one content object or at least any other content object has been previously published on the collaborative platform by the at least one user. If the at least one user has not previously published the at least one content object or the at least any other content object on the collaborative platform, the evaluation module enables at least one other user to assign a preliminary score to the at least one content object. Else if the at least one user has previously published the at least one content object or any other content object on the collaborative platform, the evaluation module enables the at least one other user to assign a secondary score to the at least one content object. Moreover the evaluation module further enables the at least one other user to optionally mark the at least one content object assigned with the secondary score as ‘substantive’ based on the content of the at least one content object. The display module is configured to selectively display the at least one content object assigned with the preliminary score, the at least one content object assigned with the secondary score, and the at least one content object marked as ‘substantive’ on the collaborative platform.

In another implementation, a method for evaluating at least one content object in a collaborative platform is disclosed. At least one content object from at least one user in the collaborative platform is received. The at least one content object received is analyzed to detect whether the content of the at least one content object is extraneous. After analyzing the content of the at least one content object, the at least one content object is published on the collaborative platform. The at least one content object is published only when the content of the at least one content object is not detected as extraneous. Thereafter a step of evaluation is performed by verifying whether the at least one content object or at least any other content object has been previously published on the collaborative platform by the at least one user. Based on the verification, If the at least one user has not previously published the at least one content object or the at least any other content object on the collaborative platform, the evaluation module enables at least one other user to assign a preliminary score to the at least one content object. Else if the at least one user has previously published the at least one content object or any other content object on the collaborative platform, the at least one other user assigns a secondary score to the at least one content object. Based on the assignment of the secondary score, the at least one other user is further enabled to optionally mark the at least one content object assigned with the secondary score as ‘substantive’. The at least one content object assigned with the preliminary score, the at least one content object assigned with the secondary score and the at least one content object marked as ‘substantive’ can selectively be displayed on the collaborative platform.

In yet another implementation, a computer program product having embodied thereon a computer program for evaluating at least one content object in a collaborative platform is disclosed. The computer program product comprises a program code for receiving the at least one content object from at least one user in the collaborative platform. A program code is configured for analyzing content of the at least one content object to detect whether the content is extraneous. A program code is configured for publishing the at least one content object on the collaborative platform when the content is not detected as extraneous. A program code is configured to verify whether the at least one content object or at least any other content object has been previously published on the collaborative platform by the at least one user. If the at least one user has not previously published the at least one content object or the at least any other content object on the collaborative platform, a program code is configured for enabling at least one other user to assign a preliminary score to the at least one content object. Else if the at least one user has previously published the at least one content object or any other content object on the collaborative platform, a program code is configured for enabling the at least one other user to assign a secondary score to the at least one content object. Based on the assignment of the secondary score, a program code is configured for enabling the at least one other user to optionally mark the at least one content object assigned with the secondary score as ‘substantive’. A program code selectively displays the at least one content object assigned with the preliminary score, the at least one content object assigned with the secondary score, and the at least one content object marked as ‘substantive’ on the collaborative platform.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for evaluating at least one content object in a collaborative platform is shown, in accordance with an embodiment of the present subject matter.

FIG. 2 illustrates the system, in accordance with an embodiment of the present subject matter.

FIG. 3 illustrates a method for evaluating at least one content object in a collaborative platform, in accordance with an embodiment of the present subject matter.

FIG. 4 illustrates a method for assigning a preliminary score and a secondary score by evaluating the at least one content, in accordance with an embodiment of the present subject matter.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. For example, although the present disclosure will be described in the context of a system and method for evaluating at least one content object in a collaborative platform used in e-learning environment, one of ordinary skill in the art will readily recognize that the method and system can be utilized in any forum where there is need to evaluate the at least one content object by assigning a preliminary score or a secondary score or by optionally marking the at least one content object as substantive in the collaborative platform. Thus, the present disclosure is not intended to be limited to the embodiments illustrated, but is to be accorded the widest scope consistent with the principles and features described herein.

System and method for evaluating the at least one content object in a collaborative e-learning platform is described. The collaborative e-learning platform may be an online discussion forum where users can converse by exchanging content objects such as posts, messages or the like. The online discussion forum may be classified into different categories such as main class, assignment group, private, Question to Instructor (QTI), mentor program, class wall, announcement, or comments. In one embodiment, the main class forum may allow the users to discuss on topics of type “Discussion Question”. Another type of forum may be assignment group forum that is created for a specific group of users to discuss on the online discussion forum. Further individual/private forum may allow the user to discuss with other in private. Yet another type of forum may be a Questions to Instructor forum (QTI) that allows the student to publish questions only to instructor.

In one embodiment of the disclosure, the online discussion forum may be created that allows and encourages the user to have conversations in the form of posted messages. The online discussion forum may be created with a specific topic of intent by the user assigned with a specific role. In one embodiment of the present disclosure, the system may be adapted to receive the at least one content object in the form of text, multimedia such as audio, video, or both, electronic documents such as spreadsheets, word processing files, html files or combinations thereof from the users wherein the user can be an administrator, course administrator, instructor, student, observer and mentor. The at least one content object received from the user may be related to the specific topic of intent. In one embodiment, various users connected to the online discussion forum may be assigned with a specific role to execute creation, deletion, edition and grading of the at least one content object on the online discussion forum.

The system receives at least one content object from the user. After receiving the at least one content object, the content of the at least one content object may be analyzed by a machine or other user such as administrator or instructor, to detect whether the content in the at least one content object is extraneous. When the extraneous content is detected in the at least one content object, the system may prompt the other user to optionally mark the at least one content object as extraneous and therefore enable the other user to discard or hide the at least one content object detected as extraneous. Alternatively, when the content of the at least one content object is not detected as extraneous, the system may publish the at least one content object on the online discussion forum. On publishing the at least one content object, the system may further enable the at least one other user to evaluate the at least one content object.

In one embodiment of the disclosure, the at least one content object published on the online discussion forum may be then evaluated. Initially the evaluation of the at least one content object may be performed by verifying whether the at least one content object or any other content object has been previously published by the at least one user on the online discussion forum. Upon verification, if it is verified that the at least one user has not previously published the at least one content object or any other content object on the online discussion forum, the other user may assign a preliminary score to the at least one content object. Else if it is verified that the at least one user has previously published the at least one content object or any other content object on the online discussion forum, the other user may assign a secondary score to the at least one content object published by the user. In one embodiment, the preliminary score and the secondary score may be assigned in the form of a grade, or a mark or a rank based on the quality of the content of the at least one content object to encourage and maintain the engagement level of the each user in the online discussion forum.

Subsequent to the assignment of the preliminary or the secondary score, the system may further enable the other user to optionally mark the at least one content object assigned with the secondary score as ‘substantive’ based on the content associated with the at least one content object and the specific topic of intent. After marking the at least one content object as ‘substantive’, the system may selectively display the at least one content object assigned with the preliminary score, the at least one content object assigned with the secondary score and the at least one content object marked as ‘substantive’ on the online discussion forum. As the at least one content object may be displayed as ‘substantive’, the users can recognize the substantive content object easily on the collaborative platform.

While aspects of described system and method for evaluating the at least one content object (post) on the collaborative platform may be implemented in any number of different computing systems, environments, and/or configurations, the embodiments are described in the context of the following exemplary system. Thus, the following more detailed description of the embodiments of the disclosure, as represented in the figures and flowcharts, is not intended to limit the scope of the disclosure, as claimed, but is merely representative of certain examples of presently contemplated embodiments in accordance with the disclosure.

The presently described embodiments will be best understood by reference to the drawings, wherein like parts are designated by like numerals throughout. Moreover, flowchart and block diagrams in the Figures illustrate the architecture, functionality, and operation of possible implementations of systems and methods according to various embodiments of the present disclosure. In this regard, each block in the flowchart or block diagrams may represent a module, segment, or portion of code, which comprises one or more executable instructions for implementing the specified logical function(s).

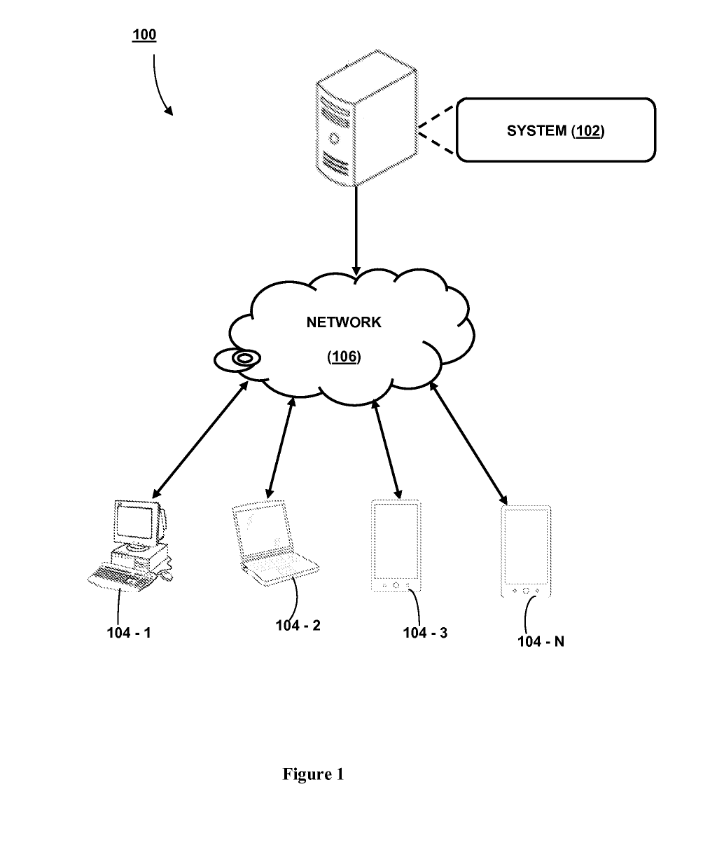

Referring now to FIG. 1, a network implementation 100 of a system 102 for evaluating at least one content object in a collaborative platform is illustrated, in accordance with an embodiment of the present subject matter. In one embodiment, the system 102 may be adapted to receive the at least one content object from at least one user connected to the collaborative platform. On receiving the at least one content object, the system 102 may be further adapted to analyze content of the at least content object to detect whether the content is extraneous. When the content is detected as extraneous, the system may prompt the other user to optionally mark the at least one content object as extraneous and therefore enable the other user to discard or hide the at least one content object detected as extraneous. After detecting the content, the system 102 may publish the at least one content object not detected as extraneous on the collaborative platform to evaluate the at least one content object. In order to evaluate the at least one content object, the system 102 may verify whether the at least one content object or any other content object has been previously published on the collaborative platform by the at least one user. Based on the verification if it is determined that the at least one user has not previously published the at least one content object or any other content object on the collaborative platform, the system 102 may further enable the at least one other user to assign a preliminary score to the at least one content object. Else if it is determined that the at least one user has previously published the at least one content object or any other content object on the collaborative platform the system 102 may enable the at least one other user to assign a secondary score to the at least one content object. After assigning the secondary score to the at least one content object, the system 102 may enable the at least one other user to optionally mark the at least one content object assigned with the secondary score as ‘substantive’ based on the content of the at least one content object. The system 102 may selectively display the at least one content object assigned with the preliminary score, the at least one content object assigned with the secondary score and the at least one content object marked as ‘substantive’ on the online discussion forum.

Although the present subject matter is explained considering that the system 102 is implemented as a collaborative platform on a server, it may be understood that the system 102 may also be implemented in a variety of computing systems, such as a laptop computer, a desktop computer, a notebook, a workstation, a mainframe computer, a server, a network server, and the like. It will be understood that the system 102 may be accessed by multiple users through one or more user devices 104-1, 104-2 . . . 104-N, collectively referred to as user 104 hereinafter, or applications residing on the user devices 104. Examples of the user devices 104 may include, but are not limited to, a portable computer, a personal digital assistant, a handheld device, and a workstation. The user devices 104 may be communicatively coupled to the system 102 through a network 106. Further, the user 104 can be at least one of a student, an instructor, a mentor and an administrator etc., collaborating over the network 106 for enabling the collaborative platform.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

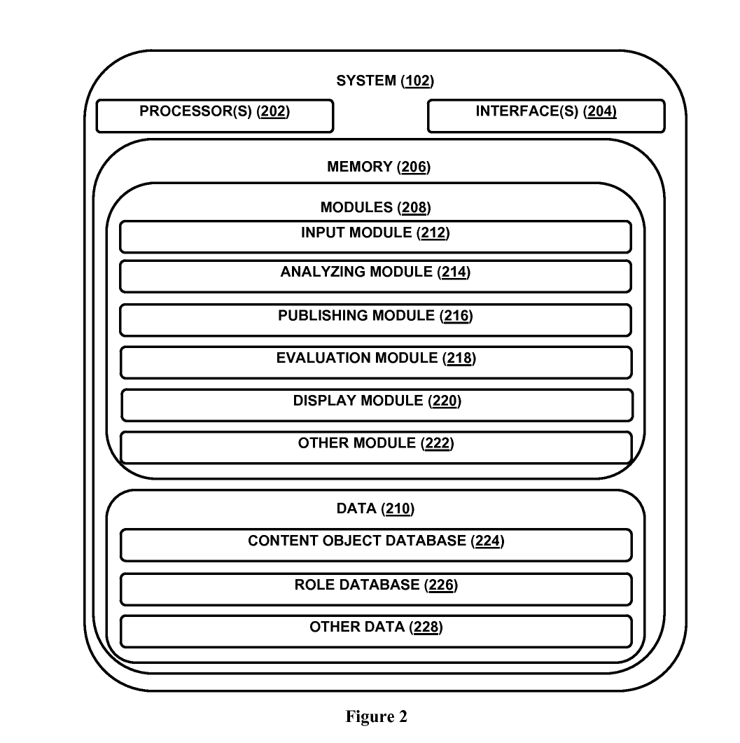

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or any computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include an input module 212, an analyzing module 214, a publishing module 216, an evaluation module 218, a display module 220 and other modules 222. The other modules 222 may include programs or coded instructions that supplement applications and functions of the system 102.

The data 210, amongst other things, may serve as a repository for storing data processed, received, and generated by one or more of the modules 208. The data 210 may also include a content object database 222, a role database 224 and other data 226. The other data 228 may include data generated as a result of the execution of one or more modules in the other module 222.

In one embodiment, at first, at least one user may use the client device 104 to access the system 102 via the I/O interface 204. The at least one user may register themselves using the I/O interface 204 in order to use the system 102. The system 102 may enable the modules to configure a collaborative platform that can be accessible by the user devices 104 through the I/O interface 204. In order to evaluate the at least one content object, the system 102 may enable the at least one user to create the collaborative platform for discussion on a specific topic used in e-learning environment. The system 102, at first, may receive at least one content object from the at least one user. Specifically, in the present embodiment, the at least one content object may be received by the input module 212 in the form of text, multimedia such as audio, video, or both, electronic documents such as spreadsheets, word processing files, html files. After receiving the at least one content object from the at least one user, the at least one content object may be stored in the content object database 222. In one embodiment if the at least one user desires to modify the at least one content object, the system 102 may retrieve the at least one content object from the content object database 222 and enables the at least one user to modify the at least one content object.

After receiving the at least one content object from the at least one user, the analyzing module 214 may enable at least one other user to analyze content of the at least one content object. In one embodiment, the at least one other user can be an administrator, course administrator, instructor, student, observer and mentor, having a specific role which are stored in the role database 224. The at least one other user may analyze the content of the at least one content object to detect whether the at least one content object contains any extraneous content. If the at least one content object contains the extraneous content, the analyzing module 214 may further enable the at least one other user to optionally mark the at least one content object as an extraneous content object and further discards the extraneous content from the content object database 222.

After analyzing the content of the at least one content object, the publishing module 216 may be adapted to publish the at least one content object on the collaborative platform which are not marked as the extraneous content object. Upon publishing the at least one content object, the evaluation module 218 may be configured to evaluate the content of the at least one content object by assigning a grade, or a mark or a rank, wherein the grade may be a preliminary score or a secondary score. In order to assign the grade, or a mark or a rank to the at least one content object, the evaluation module 218 may initially verify whether the at least one content object or any other content object has been previously published on the collaborative platform by the at least one user. If the at least one user has not previously published the at least one content object or any other content object on the collaborative platform, the evaluation module 218 may enable the at least one other user to assign the preliminary score to the at least one content object. Else if the at least one user has previously published the at least one content object or any other content object on the collaborative platform, the evaluation module 218 may further enable the at least one other user to assign the secondary score to the at least one content object. In one example of the above implementation, if the at least one content object received from the at least one user is “Regularly maintain your car for reducing air pollution”, the evaluation module 218 may be adapted to verify whether “Regularly maintain your car for reducing air pollution” or any other content object has been previously published on the collaborative platform by the at least one user. Upon verification, if it is determined that the at least one user has not previously published “Regularly maintain your car for reducing air pollution” or any other content object on the collaborative platform, the evaluation module 218 may enable the at least one other user to assign the preliminary score to “Regularly maintain your car for reducing air pollution”. On the other hand, if it is determined that the at least one user has previously published “Do not leave the engine idle in traffic for reducing air pollution” before publishing “Regularly maintain your car for reducing air pollution”, the evaluation module 218 may enable the at least one other user to assign the secondary score instead of assigning the preliminary score to “Regularly maintain your car for reducing air pollution”.

Subsequent to the assignment of the secondary score, the evaluation module 218 may further enable the at least one other user to optionally mark the at least one content object assigned with the secondary score as ‘substantive’ based on the content associated with the at least one content object. Therefore, considering the above example of content objects being evaluated, either the preliminary score or the secondary score may be assigned to “Regularly maintain your car for reducing air pollution” depending on the circumstances of it being published earlier. In first scenario, “Regularly maintain your car for reducing air pollution” may be assigned with a preliminary score, while in the second scenario, “Regularly maintain your car for reducing air pollution” may be assigned with a secondary score and can be optionally marked as substantive by the at least one user.

Upon assigning the preliminary score, the secondary score and marking the at least one content object as substantive, the display module 220 may selectively display the at least one content object assigned with the preliminary score, the at least one content object assigned with the secondary score and the at least one content object marked as ‘substantive’ on the collaborative platform. In one aspect, the display module 220 may be further adapted to display the at least one content object published on the collaborative platform in a thread (conversation style) or in a linear (chronological) way of viewing the threads and posts, which may enable specific access type to each of the students and the instructors.

Exemplary embodiments discussed above may provide certain advantages. Though not required to practice aspects of the disclosure, these advantages may include those provided by the following features:

1. Assigning a grade in form of scores to at least one content object published on the collaborative platform.

2. Optional marking of at least one content object published on the collaborative platform subsequent to content object of first instance as ‘substantive’.

3. Detecting content of the at least one content object as extraneous, wherein the content when detected as extraneous, the at least one content object can be made invisible/deleted from the platform.

4. Assisting an instructor or an administrator to evaluate the performance of a student based on the scores assigned to the at least one content object.

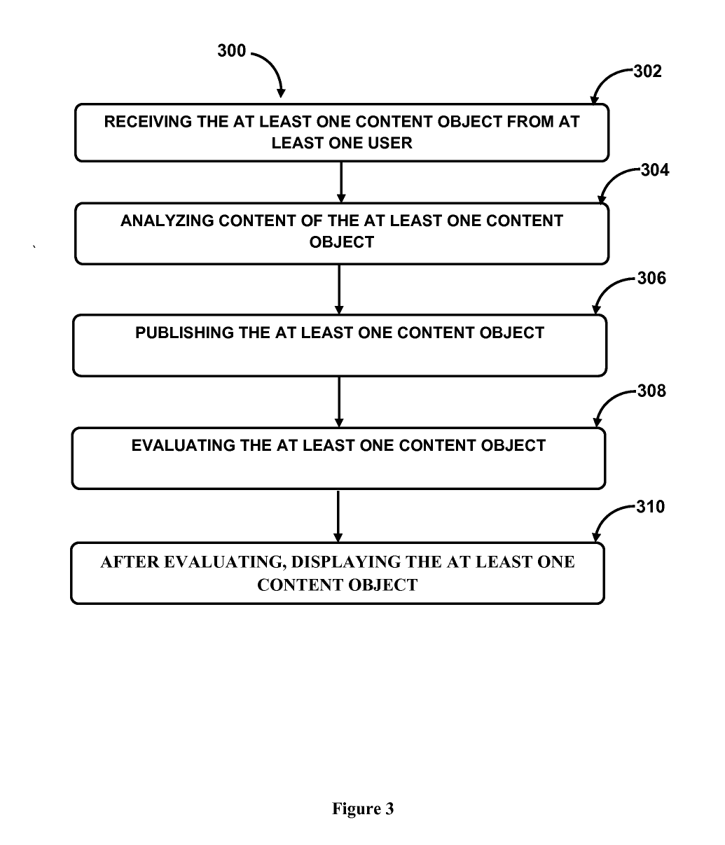

Referring now to FIG. 3, a method 300 for evaluating at least one content object in a collaborative platform is shown, in accordance with an embodiment of the present subject matter. The method 300 may be described in the general context of computer executable instructions. Generally, computer executable instructions can include routines, programs, objects, components, data structures, procedures, modules, functions, etc., that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method can be implemented in any suitable hardware, software, firmware, or combination thereof. However, for ease of explanation, in the embodiments described below, the method 300 may be considered to be implemented in the above-described system 102.

At block 302, at least one content object may be received from at least one user connected with a collaborative platform. In one implementation, the at least one content object may be received by the input module 212.

At block 304, content of the at least one content object may be analyzed to detect whether the content is extraneous. In one implementation, the at least one content object may be analyzed by the analyzing module 214.

At block 306, the at least one content object may be published on the collaborative platform. In one implementation, the at least one content object may be published by the publishing module 216.

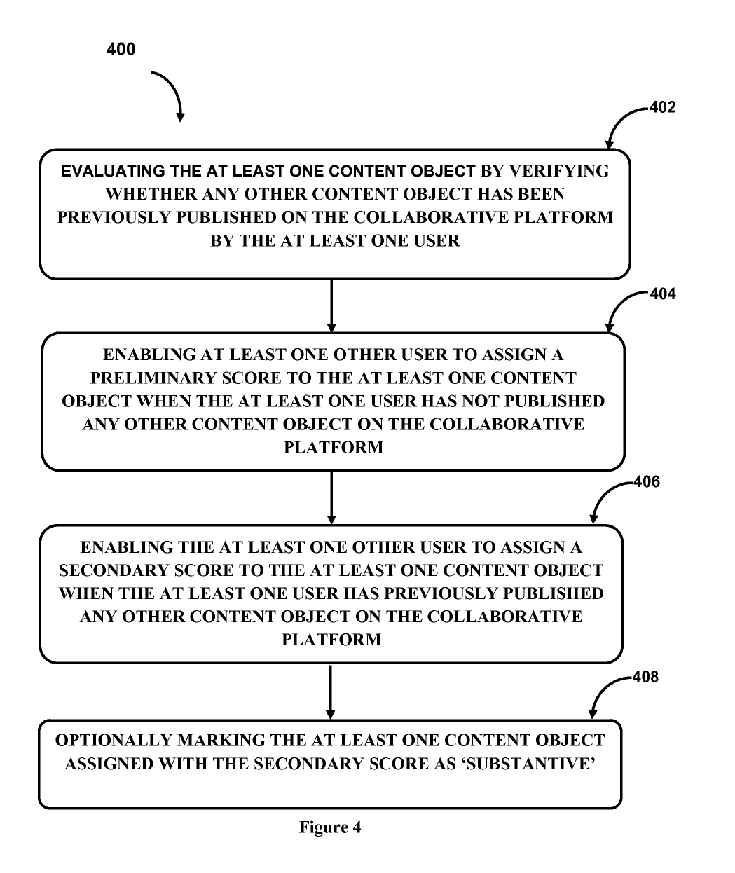

At block 308, the at least one content object may be evaluated on the collaborative platform. In one implementation, the step 308 may be performed by the evaluation module 218. Further, the block 308 may be explained in greater detail in FIG. 4.

At block 310, after evaluating, the at least one content object may be then selectively displayed on the collaborative platform by the display module 220.

Referring now to FIG. 4, a method 308 for evaluating the at least one content object is shown, in accordance with an embodiment of the present subject matter.

At block 402, the at least one content object may be evaluated by verifying whether the at least one content object or any other content object has been previously published on the collaborative platform by the at least one user.

At block 404, when the at least one user has not previously published the at least one content object or any other content object on the collaborative platform, the at least one other user may assign a preliminary score to the at least one content object.

At block 406, when the at least one user has previously published the at least one content object or any other content object on the collaborative platform, the at least one other user may assign a secondary score to the at least one content object.

At block 408, the at least one other user may be enabled to optionally mark the at least one content object assigned with the secondary score as ‘substantive’. In one implementation, the block 402 to block 408 may be performed by the evaluation module 218.

Although implementations for evaluating the at least one content object based upon analyzing the content of the at least one content object and thereby assigning a grade in the form of the preliminary score or the secondary score have been described in language specific to structural features and/or methods, it is to be understood that the appended claims are not necessarily limited to the specific features or methods described. Rather, the specific features and methods are disclosed as examples of implementations for evaluating the at least one content object on the collaborative platform.

It is intended that the disclosure and examples above be considered as exemplary only, with a true scope and spirit of disclosed embodiments being indicated by the following claims.

1. A method for evaluating at least one content object published on a collaborative platform, the method comprising:
receiving the at least one content object from at least one user in the collaborative platform;
analyzing content of the at least one content object to detect whether the content is extraneous;
publishing the at least one content object on the collaborative platform when the content is not detected as extraneous;
verifying whether the at least one content object or any other content object has been previously published on the collaborative platform by the at least one user;
evaluating the at least one content object by performing one of:
enabling at least one other user to assign a preliminary score to the at least one content object when the at least one user has not previously published the at least one content object or any other content object on the collaborative platform; and
enabling the at least one other user to assign a secondary score to the at least one content object when the at least one user has previously published the at least one content object or any other content object on the collaborative platform;
enabling the at least one other user to optionally mark the at least one content object assigned with the secondary score as ‘substantive; and
displaying selectively the at least one content object assigned with the preliminary score, the at least one content object assigned with the secondary score and the at least one content object marked as ‘substantive’ on the collaborative platform, wherein the receiving, the analyzing, the publishing, the evaluating, the enabling the at least one other user to mark, and the displaying are performed by at least one processor.

2. The method of claim 1, wherein the at least one content object comprises text, multimedia such as audio and video, electronic documents such as spreadsheets, word processing files, html files or combinations thereof.

3. The method of claim 1, wherein the at least one user is assigned at least one role selected from a group comprising of administrator, course administrator, instructor, student, observer and mentor.

4. The method of claim 1, wherein the collaborative platform can be classified into at least one type selected from a group comprising of main class, assignment group, private, Question to Instructor (QTI), mentor program, class wall, announcement, and comments.

5. The method of claim 1, wherein the at least one content object detected as extraneous may contain morally or ethically questionable content and is marked as abusive.

6. A system for evaluating at least one content object published on a collaborative platform, the method comprising:
at least one processor; and
a memory coupled to the at least one processor, wherein the at least one processor is capable of executing a plurality of modules stored in the memory, and wherein the plurality of modules comprising:
an input module configured to receive the at least one content object from at least one user in the collaborative platform;
an analyzing module configured to analyze content of the at least one content object to detect whether the content is extraneous;
a publishing module configured to publish the at least one content object on the collaborative platform when the content is not detected as extraneous;
an evaluation module configured to verify whether the at least one content object or any other content object has been previously published on the collaborative platform by the at least one user, the evaluation module in response to verification is further configured to perform one of:
enabling at least one other user to assign a preliminary score to the at least one content object when the at least one user has not previously published the at least one content object or any other content object on the collaborative platform; and
enabling the at least one other user to assign a secondary score to the at least one content object when the at least one user has previously published the at least one content object or any other content object on the collaborative platform; and
the evaluation module is further configured to enable the at least one other user to optionally mark the at least one content object assigned with the secondary score as ‘substantive’;
a display module configured to selectively displays the at least one content object assigned with the preliminary score, the at least one content object assigned with the secondary score and the at least one content object marked as ‘substantive’ on the collaborative platform;
the memory further comprising:
a content object database configured to store the at least one content object; and
a role database configured to store at least one role, wherein the at least one role is assigned to the at least one user or to the at least one other user.

7. The system of claim 6, wherein the content object database stores the at least one content comprising of text, multimedia such as audio, video, or both, electronic documents spreadsheets, word processing files, html files or combinations thereof.

8. The system of claim 6, wherein the role database comprises administrator, course administrator, instructor, student, observer and mentor.

9. A computer program product having embodied thereon a computer program for evaluating at least one content object published on a collaborative platform, the computer program product comprising:
a program code for receiving the at least one content object from at least one user in the collaborative platform;
a program code for analyzing content of the at least one content object to detect whether the content is extraneous;
a program code for publishing the at least one content object on the collaborative platform when the content is not detected as extraneous;
a program code for verifying whether the at least one content object or any other content object has been previously published on the collaborative platform by the at least one user;
a program code for evaluating the at least one content object by executing one of:
a program code for enabling at least one other user to assign a preliminary score to the at least one content object when the at least one user has not previously published the at least one content object or any other content object on the collaborative platform; and
a program code for enabling the at least one other user to assign a secondary score to the at least one content object when the at least one user has previously published the at least one content object or any other content object on the collaborative platform;
a program code for enabling the at least one other user to optionally mark the at least one content object assigned with the secondary score as substantive; and
a program code for selectively displaying the at least one content object assigned with the preliminary score, the at least one content object assigned with the secondary score and the at least one content object marked as substantive on the collaborative platform.
